(19) United States
(12) Patent Application Publication
(10) Pub. No.: US 2026/0351711 A1
(43) Pub. Date: Nov. 5, 2026

(54) AN ASSEMBLY COMPRISING A PLURALITY OF ELECTROCHEMICAL CELLS AND AN ELECTRICAL DEVICE COMPRISING SUCH ASSEMBLY

(71) Applicant: AUTOMOTIVE CELLS COMPANY SE, BRUGES (FR)

(72) Inventors: Sikandar ALI, EYSINES (FR); Laurent SIBONI, ST-MEDARD EN JALLES (FR); Pierre CHAUVEAU, BRUGES (FR); Julien LALLEMENT, LE PIAN-MÉDOC (FR)

(21) Appl. No.: 19/118,624

(22) PCT Filed: Oct. 5, 2023
(86) PCT No.: PCT/EP2023/077523

§ 371 Date: Apr. 4, 2025

(30) Foreign Application Priority Data
Oct. 5, 2022 (EP) 22306489.0

(51) Int. Cl. H01M 10/653; H01M 10/6555; H01M 50/204; H01M 50/293

(52) U.S. Cl. CPC H01M 10/653; H01M 10/6555; H01M 50/204; H01M 50/293

(57) ABSTRACT

An assembly (12) comprises a plurality of electrochemical cells (26) arranged along a transverse direction (Y), and a plurality of insulating layers (28), each of the insulating layers (28) being arranged between two adjacent electrochemical cells (26), each of the insulating layers (28) having a thermal resistance (rₜₕ) along the transverse direction (Y). The plurality of insulating layers (28) consists of a first end group (30), a central group (32) and a second end group (34), the first end group (30), the central group (32) and the second end group (34) being successive and arranged in that particular order along the transverse direction (Y). The arithmetical mean of thermal resistances (rₜₕ) of the first end group (30) and the arithmetical mean of thermal resistances (rₜₕ) of the second end group (34) are higher than the arithmetical mean of thermal resistances (rₜₕ) of the central group (32).

The present invention relates to an assembly comprising a plurality of electrochemical cells.

The invention applies in particular to the manufacturing of a battery, especially for an electric or a hybrid vehicle. By “battery” is meant a plurality of electrochemical cells electrically connected to one another. According to a particular example of a battery, the plurality of electrochemical cells is arranged in the form of one or more module(s), each module comprising a plurality of electrochemical cells electrically connected to one another and mechanically assembled to one another by an assembly system, such as assembly plates. An electrochemical cell comprises, in particular, a group of positive electrodes connected to each other and a group of negative electrodes connected to each other, separated by a separator, the combination being known as a “stack”. The positive electrodes connected to each other form a positive terminal, and the negative electrodes connected to each other form a negative terminal.

In order to prevent or delay thermal runaway between the electrochemical cells, it is well known to install insulating layers between the electrochemical cells. Such layers are for example made of a thermally insulating material.

In general, the insulating layers placed between the electrochemical cells of a battery are identical to each other.

However, in order to reach sufficient efficiency in preventing thermal propagation between the electrochemical cells at any point of the battery, expensive layers with high thermal resistance are required. This leads to an increase in the cost of the battery. While in certain worst cases, this arrangement is not sufficient in preventing thermal propagation between cells to avoid thermal runaway in neighboring battery cells at any point of the battery.

One aim of the invention is thus to provide a solution preventing thermal runway in neighboring battery cells at any point of the battery in an efficient and economical way.

To this end, the invention proposes an assembly comprising:
a plurality of electrochemical cells arranged along a transverse direction, and
   a plurality of insulating layers, each of the insulating layers extending perpendicularly to the transverse direction and being arranged along the transverse direction between two adjacent electrochemical cells, each of the insulating layers having a thermal resistance along the transverse direction.

The plurality of insulating layers consisting of a first end group of insulating layers, a central group of insulating layers and a second end group of insulating layers, the first end group, the central group and the second end group being successive and arranged in that particular order along the transverse direction.

The arithmetical mean of thermal resistances of the first end group and the arithmetical mean of thermal resistances of the second end group are higher than the arithmetical mean of thermal resistances of the central group.

In other embodiments, the assembly comprises one or several of following features, taken individually or in any technically feasible combination:
the first end group and the second end group have a same number of insulating layers;
the lowest thermal resistance in the first end group and the lowest thermal resistance in the second end group are at least 10% higher, preferably at least 50% higher, than the highest thermal resistance in the central group;
the thermal resistances of the first end group all have the same value+/−5% and the thermal resistances of the second end group all have the same value+/−5%;
the value of the thermal resistances of the first end group is equal+/−5% to the value of the thermal resistances of the second end group;
the thermal resistance of each of the insulating layers of the first end group and the thermal resistance of each of the insulating layers of the second end group increases as a function of the distance of said insulating layer from a median plan of the assembly, the median plan being perpendicular to the transverse direction;
the thermal resistances of the central group all have the same value+/−5%;
the thermal resistance of each of the insulating layers of the central group increases as a function of the distance of said insulating layer from a median plan of the assembly, the median plan being perpendicular to the transverse direction;
each of the insulating layers defines a thickness in the transverse direction, the arithmetical mean of thicknesses of the first end group and the arithmetical mean of thicknesses of the second end group being larger than the arithmetical mean of thicknesses of the central group;
the lowest thickness in the first end group and the lowest thickness in the second end group are at least 10% larger, preferably at least 50% larger, than the highest thickness in the central group;
the thicknesses of the first end group and the thicknesses of the second end group are comprised between 2 mm and 6 mm, preferably between 3 mm and 4.5 mm and/or the thicknesses of the central group are comprised between 0.1 mm and 4 mm, preferably between 0.5 mm and 3 mm;
each of the insulating layers has a thermal conductivity, the arithmetical mean of the thermal conductivities of the first end group and the arithmetical mean of the thermal conductivities of the second end group being lower than the arithmetical mean of the central group;
the insulating layers are made of a material selected from silicone, aerogel, fiberglass, Mica, and a phase-change material;
the insulating layers of the first end group and the insulating layers of the second end group are made of a first material and the insulating layers of the central group are made of a second material, the second material being different from the first material.

The invention also relates to an electrical device such as a battery module or a battery, comprising at least one assembly as previously described.

The invention and its advantages will be better understood on reading the following description given solely by way of non-limiting examples and with reference to the appended drawings, in which:

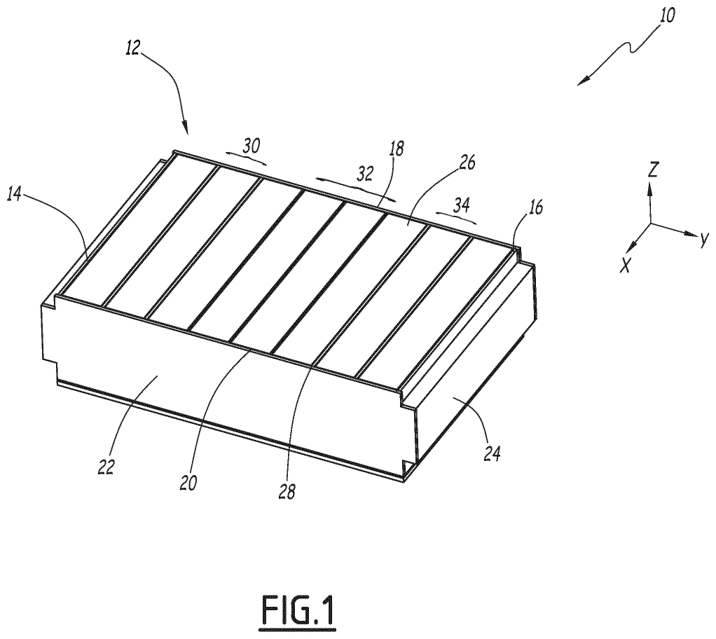

FIG. 1 is a schematic perspective view of a part of an electric device comprising an assembly according to a first embodiment of the invention;

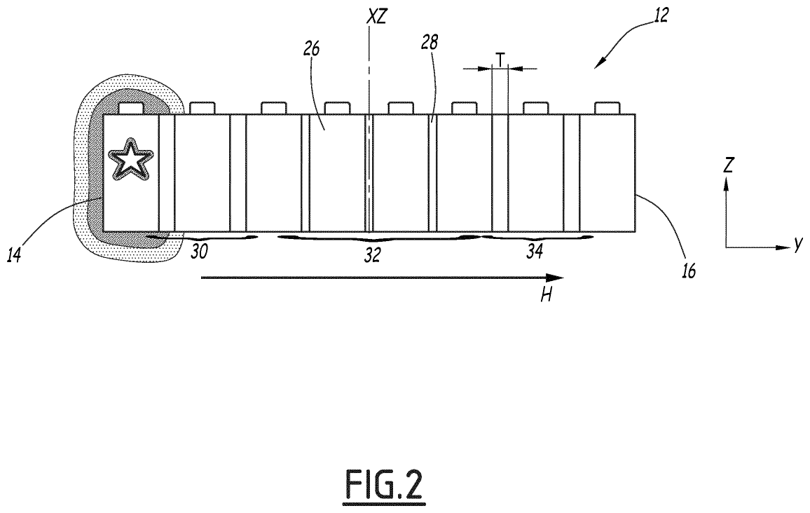

FIG. 2 is a schematic side view of the assembly depicted in FIG. 1; and

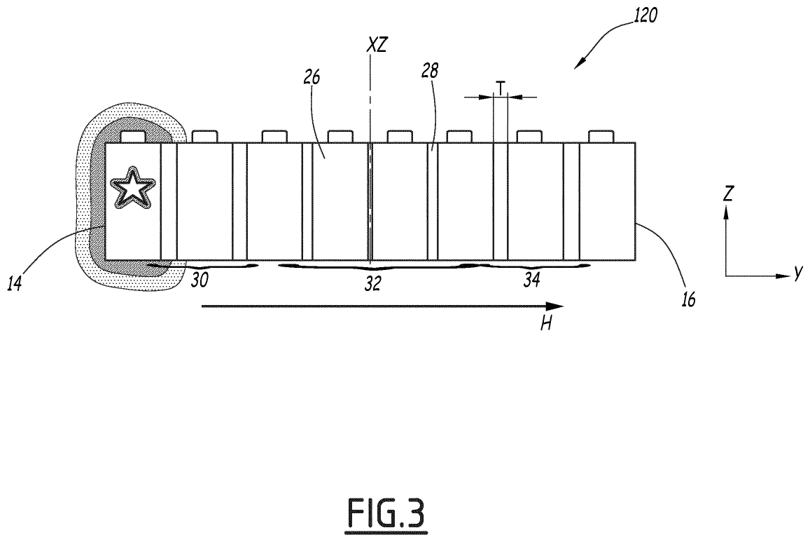

FIG. 3 is a schematic side view of an assembly according to a second embodiment of the invention.

An electrical device 10 according to a first embodiment of the invention will be described with reference to FIGS. 1 and 2.

The electrical device 10 is only partially depicted in FIG. 1 and is for example a battery, a battery pack, or a battery module intended to be assembled with other modules in order to form a battery.

The electrical device 10 is for example intended to be installed in an electric or hybrid motor vehicle (not shown).

The electrical device 10 defines a longitudinal direction X that is for example the direction of travel of the vehicle, and a transverse direction Y perpendicular to the longitudinal direction X and which is for example the transverse direction of the vehicle.

A third direction Z is further defined which is perpendicular to the longitudinal direction X and the transverse direction Y, and which is for example intended to be substantially vertical when the vehicle is on a horizontal surface (not shown).

The electrical device 10 comprises at least one assembly 12, the assembly 12 comprising a first end 14 and second end 16 opposed to each other along the transverse direction Y and further comprising a first side 18 and a second side 20 opposed to each other along the longitudinal direction X.

The electrical device 10 preferably comprises a plurality of assembly 12 electrically and mechanically connected to each other.

As shown in FIG. 1, the electrical device 10 preferably comprises, for each assembly 12, two side plates 22 and two end plates 24.

In particular, each of the two side plates 22 lies against one of the first side 18 and the second side 20 of the assembly 12, and preferably covers it entirely.

Each of the two end plates 24 lies against one of a first end 14 and second end 16 of the assembly 12, and preferably covers it entirely.

The assembly 12 comprises a plurality of electrochemical cells 26 arranged along the transverse direction Y, especially between the two end plates 24.

The assembly 12 preferably comprises at least four electrochemical cells 26.

In the example shown in the figures, the assembly 12 comprises eight electrochemical cells 26.

Furthermore, the assembly 12 comprises a plurality of insulating layers 28, each of the insulating layers 28 extending perpendicularly to the transverse direction Y, i.e. along the longitudinal direction X, and being arranged along the transverse direction Y between two adjacent electrochemical cells 26.

In particular, the assembly 12 consists of a simple alternation of electrochemical cells 26 and insulating layers 28.

Preferably, the electrochemical cells 26 and the insulating layers 28 are arranged successively against each other in the transverse direction Y, so that there is no mechanical gap between these elements.

The assembly 12 preferably comprises at least three insulating layers 28.

In particular, the assembly 12 comprises a number of insulating layer 28 corresponding to the number of electrochemical cells 26 minus one.

In the example shown in the figures, the assembly 12 comprises seven insulating layers 28.

The insulating layers 28 is for example a plate, a foam or a gel of a thermal insulating material.

Preferably, the insulating layers 28 are made of a material selected from silicone, aerogel, fiberglass, Mica, and a phase-change material.

The plurality of insulating layers 28 consists of a first end group 30 of insulating layers, a central group 32 of insulating layers and a second end 34 group of insulating layers.

Each of the first end group 30, the central group 32 and the second end group 34 comprises at least one insulating layer 28.

The first end group 30, the central group 32 and the second end group 34 are successive and arranged in that particular order along the transverse direction Y.

In particular, as shown in FIGS. 1 and 2, the insulating layers 28 of the first end group 30 are nearest to the first end 14 of the assembly 12. The insulating layers 28 of the second end group 34 are nearest to the second end 16 of the assembly 12. The insulating layers 28 of central group 32 are located between the insulating layers 28 of the first end group 30 and the insulating layers 28 of the second end group 34 along the transverse direction Y.

Preferably, the first end group 30 and the second end group 34 have a same number of insulating layers 28.

In the example shown in FIGS. 1 and 2, each of the first end group 30 and the second end group 34 is composed of two insulating layers 28, and the central group 34 is composed of three insulating layers 28.

Advantageously, the first end group 30 and the second end group 34 are symmetrical to each other with respect to a median plane XZ of the assembly 12. The median plan XZ of the assembly 12 is a plane perpendicular to the transverse direction Y and is preferably at the same distance from each end 14, 16 of the assembly 12.

Each of the insulating layers 28 has a thermal resistance rₜₕ along the transverse direction Y. This thermal resistance rₜₕ quantifies the surface resistance to a heat flow along the transverse direction Y between two isotherms. For each insulating layer 28, the two isotherms are preferably two plane surfaces of the insulating layer 28 parallel to each other, each lying against one of the corresponding electrochemical cells 26.

The thermal resistance rₜₕ along the transverse direction Y of each of the insulating layers 28 is for example defined by the following formula:

$${r}_{th} = \frac{T}{λ} ,$$

wherein T is the thickness of the insulating layer 28 and A is the thermal conductivity of the insulating layer 28.

More specifically, the thickness T of each insulating layer 28 is defined in the transverse direction Y, and corresponds to the gap along the transverse direction Y between the two nearby electrochemical cells 26 as illustrated in FIG. 2.

According to the invention, the arithmetical mean of thermal resistances rₜₕ of the first end group 30 and the arithmetical mean of thermal resistances rₜₕ of the second end group 34 are higher than the arithmetical mean of thermal resistances rₜₕ of the central group 32.

Preferably, the lowest thermal resistance rₜₕ in the first end group 30 and the lowest thermal resistance rₜₕ in the second end group 34 are at least 10% higher, preferably at least 50% higher, than the highest thermal resistance rₜₕ in the central group 32.

In the first embodiment of the invention, the thermal resistances ren of the first end group 30 all have the same value+/−5% and the thermal resistances rₜₕ of the second end group 34 all have the same value+/−5%.

More specifically, the value of the thermal resistances rₜₕ of the first end group 30 is equal+/−5% to the value of the thermal resistances rₜₕ of the second end group 34.

Moreover, in the first embodiment of the invention, the thermal resistances rₜₕ of the central group 32 all have the same value+/−5%.

More particularly, in the first embodiment of the invention illustrated in FIGS. 1 and 2, the thermal conductivities λ of the insulating layers 28 of the assembly 12 all have the same value+/−5% and the variation of thermal resistances rₜₕ is obtained by a variation of thicknesses T of the insulating layers 28.

To this end, the arithmetical mean of thicknesses T of the first end group 30 and the arithmetical mean of thicknesses T of the second end group 34 are larger than the arithmetical mean of the thicknesses T of the central group 32.

Preferably, the lowest thickness T in the first end group 30 and the lowest thickness T in the second end group 34 are at least 10% larger, preferably at least 50% larger, than the highest thickness T in the central group 32.

More specifically, as shown in FIG. 2, the thicknesses T of the first end group 30 all have the same value+/−5% and the thicknesses T of the second end group 34 all have the same value+/−5%.

Preferably, the value of the thicknesses T of the first end group 30 is equal to the value of the thicknesses T of the second end group 34.

For example, the thicknesses T of the first end group 30 and the thicknesses T of the second end group 34 are comprised between 2 mm and 6 mm, preferably between 2.5 mm and 4.5 mm.

Moreover, as shown in FIG. 2, the thicknesses T of the central group 32 all have the same value+/−5%.

For example, the thicknesses T of the insulating layers 28 of the central group 32 are comprised between 0.1 mm and 4 mm, preferably between 0.5 mm and 3 mm.

The behavior of such assembly 12 in case of heating in one of the electrochemical cells 26 will now be described with reference to FIG. 2.

As shown in FIG. 2, when heat is generated at an electrochemical cell 26 near the first end 14 of the assembly 12, the heat H propagates to the neighboring electrochemical cells 26 along the transverse direction Y towards the second end 16.

The same applies when heat is generated at an electrochemical cell 26 near the second end 16 of the assembly 12.

On the contrary, when heat is generated at an electrochemical cell 26 near the median plan XZ of the assembly 12, i.e. in the middle of the assembly 12, the heat propagates to the neighboring electrochemical cells 26 along the transverse direction Y in both ways, i.e. towards the first end 14 and towards the second end 16.

As the heat is propagated in both ways, the thermal resistance required in the middle of the assembly 12 is actually smaller as the thermal resistance required near the ends 14, 16 of the assembly.

Thus, the smaller thermal resistances rₜₕ of the central group 32 are sufficient to prevent, or at least delay, the thermal runaway propagating in both ways in the middle of the assembly 12.

Furthermore, the higher thermal resistances rₜₕ of the first end group 30 and of the second end group 34 allow efficiently preventing, or at least delaying, the thermal runaway propagating in only one way.

The assembly 12 according to the invention therefore allows preventing thermal runway in the electrical device 10 in an efficient way at any point of the battery.

Indeed, such variation of the thermal resistance rₜₕ along the transverse direction Y, and in particular of the thickness T, of the insulating layers 28 allows optimizing the thermal insulation by adapting the thermal resistance rₜₕ according to the position along the transverse direction Y, and thus according to the required thermal insulation.

This allows reducing the cost of the insulating layers 28, and thus of the electrical device 10.

Furthermore, this allows reducing the total length of the assembly 12 along the transverse direction Y by avoiding the use of too thick insulating layers 28.

This advantage makes it possible to increase the energy density of the electrical device 10.

With reference to FIG. 3, an assembly 120 according to a second embodiment of the invention is described. The assembly 120 is analogous to the assembly 12 shown in FIGS. 1 and 2. Similar elements have the same numerical references and will not be described again. Only the differences will be described in detail below.

Unlike the first embodiment, the thermal resistances rₜₕ of the first end group 30 do not all have the same value and the thermal resistances rₜₕ of the second end group 34 do not all have the same value.

More particularly, in this second embodiment, the thermal resistance rₜₕ of each of the insulating layers 28 of the first end group 30 and the thermal resistance rₜₕ of each of the insulating layers 28 of the second end group 34 increases as a function of the distance of said insulating layer 28 from the median plan XZ of the assembly 12.

In other words, the further away an insulating layer 28 of the first end group 30 is from the median plan XZ of the assembly 12, the higher is the thermal resistance rₜₕ of said insulating layer 28. The same applies for the insulating layers 28 of the second end group 34.

In particular, as shown in FIG. 3, the thickness T of each of the insulating layers 28 of the first end group 30 and the thickness T of each of the insulating layers 28 of the second end group 34 increases as a function of the distance of the insulating layer 28 from the median plan XZ of the assembly 12.

In the example showed in FIG. 3, the thicknesses T of the first end group 30 and the thicknesses T of the second end group 34 increase with a constant step, for example equal to 0.5 mm.

Furthermore, unlike the first embodiment, the thermal resistances rₜₕ of the central group 32 do not all have the same value.

More particularly, in this second embodiment, the thermal resistance rₜₕ of each of the insulating layers 28 of the central group 32 increases as a function of the distance of said insulating layer 28 from the median plan XZ of the assembly 12.

In other words, the further away an insulating layer 28 of the central group 32 is from the median plan XZ of the assembly 12, the higher is the thermal resistance rₜₕ of said insulating layer 28.

In particular, as shown in FIG. 3, the thickness T of each of the insulating layers 28 of the central group 32 increases as a function of the distance of said insulating layer 28 from the median plan XZ.

In the example showed in FIG. 3, the thicknesses T of the insulating layers 28 of the central group 32 increase with a constant step, for example equal to 0.5 mm.

The invention is not limited to the previously described embodiments illustrated in the drawings.

In particular, a combination of the first embodiment and the second embodiment is possible.

More specifically, as a variant, the thermal resistances rₜₕ of the first end group 30 all have the same value+/−5% and the thermal resistances rₜₕ of the second end group 34 all have the same value+/−5%. However, the thermal resistance rₜₕ of each of the insulating layers 28 of the central group 32 increases as a function of the distance of said insulating layer 28 from the median plan XZ of the assembly 12.

In another variant, the thermal resistance rₜₕ of each of the insulating layers 28 of the first end group 30 and the thermal resistance rₜₕ of each of the insulating layers 28 of the second end group 34 increases as a function of the distance of said insulating layer 28 from the median plan XZ of the assembly 12. However, the thicknesses T of the central group 32 all have the same value+/−5%.

In another particular embodiment of the invention (not shown), the thicknesses T of the insulating layers 28 of the assembly 12 all have the same value+/−5% and the variation of thermal resistances rₜₕ is obtained by a variation of thermal conductivities λ of the insulating layers 28.

Particularly, the arithmetical mean of the thermal conductivities λ of the insulating layers 28 of the first end group 30 and the arithmetical mean of the thermal conductivities of the second end group 34 are lower than the arithmetical mean of the thermal conductivities λ of the insulating layers 28 of the central group 32.

All the embodiments and variants described above for the variation of thicknesses T also apply to the variation of thermal conductivities λ of the insulating layers 28.

The variation of thermal conductivities λ of the insulating layers 28 is for example obtained by selecting different insulating materials according to the desired thermal conductivity λ.

For example, the insulating layers 28 of the first end group 30 and the insulating layers 28 of the second end group 34 are made of a first material and the insulating layers 28 of the central group 32 are made of a second material, the second material being different from the first material.

Preferably, the first material has a lower thermal conductivities λ than the second material.

The first material and the second material are preferably selected from silicone, aerogel, fiberglass, Mica, and a phase-change material.

In another particular embodiment of the invention not shown, the variation of thermal resistances rₜₕ is obtained by variation at the same time of thicknesses T and of the thermal conductivities λ of the insulating layers 28, according to the one of the embodiments and variants described above.

1. An assembly comprising:
a plurality of electrochemical cells arranged along a transverse direction, and
a plurality of insulating layers, each of the insulating layers extending perpendicularly to the transverse direction and being arranged along the transverse direction between two adjacent electrochemical cells, each of the insulating layers having a thermal resistance along the transverse direction,
the plurality of insulating layers consisting of a first end group of insulating layers, a central group of insulating layers and a second end group of insulating layers, the first end group, the central group and the second end group being successive and arranged in that particular order along the transverse direction,
wherein the arithmetical mean of thermal resistances of the first end group and the arithmetical mean of thermal resistances of the second end group are higher than the arithmetical mean of thermal resistances of the central group.

2. The assembly according to claim 1, wherein the first end group and the second end group have a same number of insulating layers.

3. The assembly according to claim 1, wherein the lowest thermal resistance in the first end group and the lowest thermal resistance in the second end group are at least 10% higher than the highest thermal resistance in the central group.

4. The assembly according to claim 1, wherein the thermal resistances of the first end group all have the same value+/−5% and the thermal resistances of the second end group all have the same value+/−5%.

5. The assembly according to claim 4, wherein the value of the thermal resistances of the first end group is equal+/−5% to the value of the thermal resistances of the second end group.

6. The assembly according to claim 1, wherein the thermal resistance of each of the insulating layers of the first end group and the thermal resistance of each of the insulating layers of the second end group increases as a function of the distance of said insulating layer from a median plan of the assembly, the median plan being perpendicular to the transverse direction.

7. The assembly according to claim 1, wherein the thermal resistances of the central group all have the same value+/−5%.

8. The assembly according to claim 1, wherein the thermal resistance of each of the insulating layers of the central group increases as a function of the distance of said insulating layer from a median plan of the assembly, the median plan being perpendicular to the transverse direction.

9. The assembly according to claim 1, wherein each of the insulating layers defines a thickness in the transverse direction, the arithmetical mean of thicknesses of the first end group and the arithmetical mean of thicknesses of the second end group being larger than the arithmetical mean of thicknesses of the central group.

10. The assembly according to claim 9, wherein the lowest thickness in the first end group and the lowest thickness in the second end group are at least 10% larger than the highest thickness in the central group.

11. The assembly according to claim 1, wherein the thicknesses of the first end group and the thicknesses of the second end group are comprised between 2 mm and 6 mm and/or the thicknesses of the central group are comprised between 0.1 mm and 4 mm.

12. The assembly according to claim 1, wherein each of the insulating layers has a thermal conductivity, the arithmetical mean of the thermal conductivities of the first end group and the arithmetical mean of the thermal conductivities of the second end group-being lower than the arithmetical mean of the central group.

13. The assembly according to claim 1, wherein the insulating layers are made of a material selected from silicone, aerogel, fiberglass, Mica, and a phase-change material.

14. The assembly according to claim 1, wherein the insulating layers of the first end group and the insulating layers of the second end group are made of a first material and the insulating layers of the central group are made of a second material, the second material being different from the first material.

15. An electrical device, such as a battery module or a battery, comprising at least one assembly according to claim 1.

16. The assembly according to claim 1, wherein the lowest thermal resistance (rₜₕ) in the first end group and the lowest thermal resistance in the second end group are at least 50% higher than the highest thermal resistance in the central group.

17. The assembly according to claim 9, wherein the lowest thickness in the first end group and the lowest thickness in the second end group are at least 50% larger than the highest thickness in the central group.

18. The assembly according to claim 1, wherein the thicknesses of the first end group and the thicknesses of the second end group are comprised between 3 mm and 4.5 mm and/or the thicknesses of the central group are comprised between 0.1 mm and 4 mm.

19. The assembly according to claim 1, wherein the thicknesses of the first end group and the thicknesses of the second end group are comprised between 2 mm and 6 mm and/or the thicknesses of the central group are comprised between 0.5 mm and 3 mm.
